(19) United States
(12) Patent Application Publication
(10) Pub. No.: US 2007/0060392 A1
(43) Pub. Date: Mar. 15, 2007

(54) Game controller

(76) Inventor: Paul J. Sullivan, Newport, RI (US)

Correspondence Address: STRATEGIC PATENTS P.C.., C/O PORTFOLIOIP, P.O. BOX 52050, MINNEAPOLIS, MN, 55402, US

(21) Appl. No.: 11/202,425

(22) Filed: Aug. 11, 2005

(51) Int. Cl. G06F 19/00

(52) U.S. Cl. 463/47

(57) ABSTRACT

A game controller includes four primary buttons for user input. The primary buttons may be spaced equidistant from the perimeter of a generally rounded, hand-held controller. In one embodiment, the buttons may be specifically positioned for activation by the thumbs of a user when the controller is cradled in two hands. The controller may optionally include one or more secondary buttons used for game set up, controller configuration, and the like, as well as supplemental inputs and/or outputs.

### BACKGROUND

A number of game controllers have been devised for various gaming platforms, such as joysticks, game pads, yolks, pedals, steering wheels, and the like. As gaming has become increasingly sophisticated, the number and type of inputs and outputs for controllers has increased significantly. There remains a need for a simplified controller adapted for use in narrowly-defined gaming environments, such as online or home trivia games.

### SUMMARY OF THE INVENTION

A game controller includes four primary buttons for user input. The primary buttons may be spaced equidistant from the perimeter of a generally rounded, hand-held controller. In one embodiment, the buttons may be specifically positioned for activation by the thumbs of a user when the controller is cradled in two hands. The controller may optionally include one or more secondary buttons used for game set up, controller configuration, and the like, as well supplemental inputs and/or outputs.

### BRIEF DESCRIPTION OF THE FIGURES

The foregoing and other objects and advantages of the invention will be appreciated more fully from the following further description thereof, with reference to the accompanying drawings, wherein:

FIG. 1 shows a gaming system.

FIG. 2 shows a top view of a game controller.

FIG. 3 shows a functional block diagram of a game controller.

### DETAILED DESCRIPTION

Various embodiments of the present invention are described below, including certain embodiments relating particularly to a four-button wireless controller for use with an Internet-hosted trivia game. However, it should be appreciated that the present invention is not limited to any particular game format, communications interface, or game features, and that the various embodiments discussed explicitly herein are primarily for purposes of illustration. For example, the controller may be a four-button wireless controller that communicates directly with an IEEE 802.11 router in a multiplayer game hosted locally by a consumer's computer. Or the controller may be a four-button, USB-connected controller connected to a home computer for participating in a spatially-oriented Internet game involving four temporally forward game play selections of forward, backward, left, and right. The embodiments described herein are provided by way of example only, and are not intended to limit the scope of the inventive concepts disclosed herein.

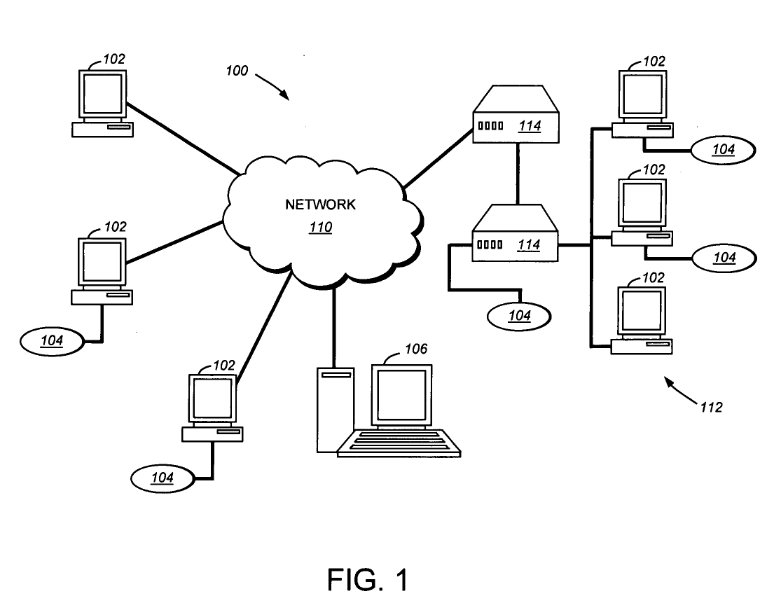

FIG. 1 shows a gaming system. The system 100 may provide a platform for participation of one or more users in a game. As described generally, the game may be played locally or remotely, and may be hosted at a user's computer, or by a remote game host. Thus various game systems may be local or distributed, and all such configurations are intended to fall within the scope of a game system as that term is used herein.

As shown in FIG. 1, a game system 100 may include a plurality of clients 102 and a game host 106 connected via an internetwork 110. Any number of clients 102 and hosts 106 may participate in such a system 100. The game system 100 may further include one or more local area networks (“LAN”) 112 interconnecting clients 102 through a hub 114 (in, for example, a peer network such as a wired or wireless Ethernet network) or a local area network server 114 (in, for example, a client-server network). The LAN 112 may be connected to the internetwork 110 through a gateway 116, which provides security to the LAN 112 and ensures operating compatibility between the LAN 112 and the internetwork 110. Any data network may be used as the internetwork 110 and the LAN 112.

In one embodiment, the internetwork 110 is the Internet, and the World Wide Web provides a system for interconnecting clients 102 and game hosts 104 in a communicating relationship through the Internet 110. The internetwork 110 may also, or instead, includes a cable network, and at least one of the clients 102 may be a set-top box, cable-ready game console, or the like. The internetwork 110 may include other networks, such as satellite networks, the Public Switched Telephone Network, WiFi networks, WiMax networks, cellular networks, and any other public, private, or dedicated networks that might be used to interconnect devices for transfer of data in a game system 100.

An exemplary client 102 may include a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as a modem, a digital subscriber line (“DSL”) card, a cable modem, a network interface card, a wireless network card, or any other interface device capable of wired, fiber optic, or wireless data communications. One example of such a client 102 is a personal computer equipped with an operating system such as Microsoft Windows XP, UNIX, or Linux, along with software support for Internet communication protocols. The personal computer may also include a browser program, such as Microsoft Internet Explorer, Netscape Navigator, or FireFox to provide a user interface for access to the internetwork 110. In the gaming system 100, the client 102 may also, or instead, execute special purpose software for participation in a game hosted by the game host 106.

Although the personal computer is a typical client 102, the client 102 may also be a workstation, mobile computer, Web phone, VoIP device, television set-top box, interactive kiosk, personal digital assistant, wireless electronic mail device, or other device capable of communicating over the Internet. As used herein, the term “client” is intended to refer to any of the above-described clients 102 or other client devices, and the term “browser” is intended to refer to any of the above browser programs or other software or firmware providing a user interface for navigating an internetwork 110 such as the Internet. While the game controller 104 described below serves as a device for game play, it will be appreciated that the client 102 may be used for various game management tasks such as registration, log in, game initiation, and display of a game and game results. Thus in one embodiment, a significant portion of game processing may be performed at the client 102, with the game controller 104 serving primarily to receive user inputs during game play. In other embodiments, the game controller 104 may serve as a stand alone gaming device that includes, e.g. a display output, an Internet-ready communications interface, processing for security, authentication, score keeping, time tracking and so on, as well as an auxiliary keyboard for entering user data and the like.

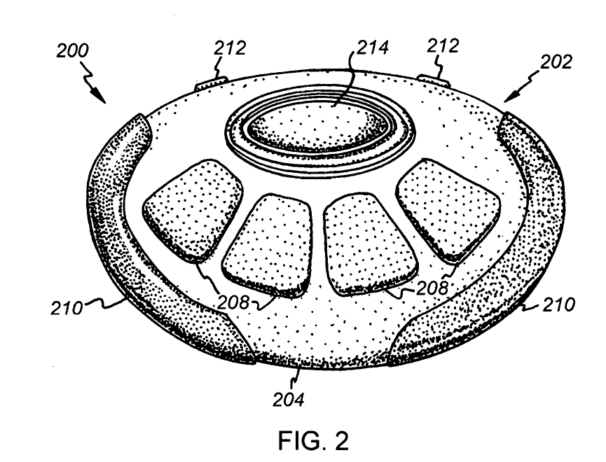

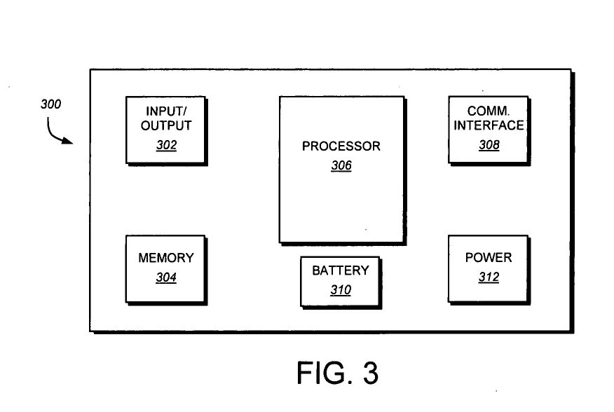

A game controller 104, which will be described in greater detail below with reference to FIGS. 2 and 3, may connect to a client 102 using any suitable communications interface. The communications interface may, for example, include one or more of wireless Ethernet, IEEE 802.11 protocols, FireWire, Bluetooth, USB, serial connections, IrDA, twisted pair (using any proprietary or standardized communications protocol), and the like. More generally, the communications interface may employ and wired or wireless communications technique employing a medium such as physical connection, radio frequency, infrared, or any other electrical or electromagnetic signal propagation medium suitable for data communications. In certain embodiments, the game controller 104 may include a communications interface for direct connection to the Internet, such as a network interface card for connecting to a DSL or cable modem, or the game controller 104 may include a communications interface for connecting directly to a local area network 112. Any of these communications interfaces, or other communications interfaces, may be used with the controller 104 described herein. Although not explicitly depicted, it will be appreciated that the controller 104 may communicate with a communications peripheral connected to the client 102. For example, a USB device may be physically connected to the client 102, and provide a radio frequency or infrared link to the controller 104.

An exemplary game host 106 may be a server including a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic, and may include separate servers for different functions such as a database server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Hewlett Packard, IBM, and Sun Microsystems. Generally, a game host 106 operates to provide game content and coordinate individual game play or multiplayer game play among a plurality of participants. In one embodiment, the game host 106 operates as a server for a multiplayer trivia game among a number of participants communicating with the game host 106 over the Internet. While the game host 106 may be at a remote Internet location, it will be appreciated that the game host 106 may also be a user's personal computer, with other users participating in a game through remote connections to the personal computer such as through the Internet or within a wireless local area network. The game host 106 may also, or instead, host a game where a user specifies a direction (such as in a spatially-oriented, first-person game), a move on a game board, a selection of an option, or some other temporally forward selection in game play.

Game content provided by the game host 106 may include, for example, a multiplayer trivia game with content including a plurality of multiple choice questions hosted by the game host 106. The game host 106 may present questions to users in a format such as HTML suitable for display at clients 102. Participants may select one of a plurality of possible answers using buttons of the controller 104, described in greater detail below, and the user selections may be gathered at the game host 106 and processed to allocate points to each user according to, for example, accuracy and time. The game host 106 may also, for example, initiate and conclude games, provide aggregate game results such as total scores, high scores, and the like, and may provide rewards to participants including cash, prizes, discounts, store credits, and the like. While the particular game format does not limit the meaning of the term “controller” as used herein, it should also be appreciated that games may include tournaments, leagues, and ad hoc play in a variety of combinations. The game host 106 may also process new participants, charge fees for entering games, and perform other management and financial transactions such as award of prizes. Financial transactions may use, for example, credit card authorization, PayPal, or any other suitable medium for receiving and transmitting money. In addition, the game host 106 may support supplementary functions such as online chat, instant messaging, electronic mail (such as for invitations to games), and electronic commerce such as shopping and advertising.

Focusing now on the internetwork 110, one embodiment is the Internet. The structure of the Internet 110 is well known to those of ordinary skill in the art and includes a network backbone with networks branching from the backbone. These branches, in turn, have networks branching from them, and so on. The backbone and branches are connected by routers, bridges, switches, and other switching elements that operate to direct data through the internetwork 110. For a more detailed description of the structure and operation of the Internet 110, one may refer to “The Internet Complete Reference,” by Harley Hahn and Rick Stout, published by McGraw-Hill, 1994. While the Internet is one well-known data network, one may practice the present invention on a wide variety of communication networks. For example, the internetwork 110 can include interactive television networks, telephone networks, wireless voice or data transmission systems, two-way cable systems, customized computer networks, Asynchronous Transfer Mode networks, and so on. Clients 102 may access the internetwork 110 through an Internet Service Provider (“ISP”, not shown) or through a dedicated DSL service, ISDN leased lines, T1 lines, OC3 lines, digital satellite service, cable modem service, or any other connection, or through an Internet Service Provider (“ISP”) providing same.

In its present deployment as the Internet, the internetwork 110 includes a worldwide computer network that communicates using the well-defined Transmission Control Protocol (“TCP”) and Internet Protocol (“IP”) to provide transport and network services. Computer systems that are directly connected to the Internet 110 each have a unique IP address. The IP address consists of four one-byte numbers (although a planned expansion to sixteen bytes is underway with IPv6). To simplify Internet addressing, the Domain Name System (“DNS”) was created. The DNS allows users to access Internet resources with a simpler alphanumeric naming system. A DNS name consists of a series of alphanumeric names separated by periods. When a domain name is used, the computer accesses a DNS server to obtain the explicit four-byte IP address. It will be appreciated that other internetworks 110 may be used with the invention. For example, the internetwork 110 may be a wide-area network, a local area network, a campus area network, or corporate area network. The internetwork 110 may be any other network used to communicate data, such as a cable broadcast network.

To further define the resources on the Internet 110, the Uniform Resource Locator system was created. A Uniform Resource Locator (“URL”) is a descriptor that specifically defines a type of Internet resource along with its location. URLs have the following format:

resource-type://domain.address/path-name

where resource-type defines the type of Internet resource. Web documents are identified by the resource type “http” which indicates that the hypertext transfer protocol should be used to access the document. Other common resource types include “ftp” (file transmission protocol), “mailto” (send electronic mail), “file” (local file), and “telnet.” The domain address defines the domain name address of the computer that the resource is located on. Finally, the path-name defines a directory path within the file system of the server that identifies the resource. As used herein, the term “IP address” is intended to refer to the four-byte Internet Protocol address, and the term “Web address” is intended to refer to a domain name address, along with any resource identifier and path name appropriate to identify a particular Web resource. The term “address,” when used alone, may refer to either a Web address or an IP address.

In an exemplary embodiment, a browser executing on one of the clients 102 retrieves a Web document at an address from one of the game hosts 106 via the internetwork 110, and displays the Web document on a viewing device, e.g., a screen. A user can retrieve and view the Web document by entering, or selecting a link to, a URL in the browser. The browser then sends an http request to the game host 106 that has the Web document associated with the URL. The game host 106 may respond to the http request by sending the requested Web document to the client 102. The Web document may be an HTTP object that includes plain text (ASCII) conforming to the HyperText Markup Language (“HTML”). Other markup languages are known and may be used on appropriately enabled browsers and servers, including the Dynamic HyperText Markup Language (“DHTML”), the eXtensible Markup Language (“XML”), the Extensible Hypertext Markup Language (“XHML”), and the Standard Generalized Markup Language (“SGML”).

Each Web document usually contains hyperlinks to other Web documents. The browser displays the Web document on the screen for the user and the hyperlinks to other Web documents are emphasized in some fashion such that the user can identify and select each hyperlink. To enhance functionality, a game host 106 may execute programs associated with Web documents using programming or scripting languages, such as Perl, C, C++, C#, or Java, or a Common Gateway Interface (“CGI”) script to access applications on the game host 106. A game host 106 may also, or instead, use server-side scripting languages such as ColdFusion from MacroMedia or PHP. These programs and languages may perform “back-end” functions such as order processing, database management, and content searching. A Web document may also contain, or include references to, small client-side applications, or applets, that are transferred from the game host 106 to the client 102 along with a Web document and executed locally by the client 102. Java is one popular example of a programming language used for applets. The text within a Web document may further include (non-displayed) scripts that are executable by an appropriately enabled browser, using a scripting language such as JavaScript or Visual Basic Script. Browsers may further be enhanced with a variety of helper applications to interpret various media including still image formats such as JPEG and GIF, document formats such as PS and PDF, motion picture formats such as AVI and MPEG, animated media such as Flash media, and sound formats such as MP3, WAV, and MIDI. These media formats, along with a growing variety of proprietary media formats, may be used to enrich a user's interactive and audio-visual experience as each Web document is presented through the browser. The term “page” as used herein is intended to refer to the Web document described above, as well as any of the above-described functional or multimedia content associated with the Web document.

Having described a gaming system 100 in general terms, a game controller for use with the gaming system 100 is now described in more detail.

FIG. 2 shows a top view of a game controller. The controller 200 may include a body 202 with a generally rounded perimeter 204, four primary buttons 208, one or more grip portions 210, one or more secondary buttons, and one or more supplemental user inputs/outputs 214.

The body 202 may be formed of any plastic, polymer, or other composite material suitable for use in a consumer electronics or gaming device. The body may have a generally rounded perimeter 204 free from sharp angles, edges, or protrusions. While the ellipse depicted in FIG. 2 is an example of a shape with a generally rounded perimeter 204, it should be appreciated that any shape generally free of angles may be used, including other rounded shapes such as a circle, a substantially circular shape, a toroid, a substantially toroidal shape, or a substantially elliptical shape. In addition, rectilinear shapes such as a square, a triangle, or a trapezoid, or any other shape, may have edges rounded to be generally rounded as that term is used herein. It should also be appreciated that, while the body 202 depicted in FIG. 2 forms a generally flattened circular prism or cylinder (again with rounded edges when viewed from any side), other profiles may be used, such that the controller 200 forms a sphere, or a cube, pyramid, or any other three-dimensional shape, again with rounded edges.

To accommodate user ergonomics such as extended play time, the body 202 may be adapted to be comfortably cradled in a typical user's fingers and/or palms. The body 202 may have a size adapted to conveniently fit with a user's hands such as about six inches, or between about five and about seven inches, or between about four and about eight inches along a major axis (from left to right in FIG. 2). The body 202 may also be about four inches, or between about three and about five inches, or between about two and about six inches along a minor axis (from top to bottom in FIG. 2). The body 202 may be about one inch, or between about one-half inch or one and one-half inches in thickness. These ranges are offered by way of example only, and it will be appreciated that other dimensions may usefully be used.

The four primary buttons 208 may receive user inputs during game play on a game system such as any of the local or networked game systems described above. The buttons 208 may be positioned so that they are equally distant from the perimeter 204. The buttons 208 may be arranged for convenient access by a user's thumbs when the controller is cradled in the user's hands and palms. The buttons 208 may be positioned approximately equidistant from one another, as depicted in FIG. 2, or the buttons 208 may be positioned in some other symmetrical pattern about the minor axis or some other axis of the body 202. More generally, the buttons 208 may be asymmetrically or otherwise arranged, though in a preferred embodiment the buttons 208 remain readily accessible to a user's thumbs. The buttons 208 may have different colors, such as red, green, blue, and yellow, and may optionally include a light such as an LED or incandescent bulb under a translucent surface, so that they may illuminate to acknowledge activation, or in response to a game event, such as by flashing when a correct input is received or when an incorrect input is received. In general, the buttons 208 may have a generally rectangular shape, a generally circular shape, a generally triangular shape or some other shape. In one embodiment, the buttons 208 may have at least one edge generally matching an adjacent section of the perimeter 204 of the body 202. The buttons 208 may function to receive user inputs to game play from a user's thumbs.

The game controller 200 may optionally include one or more grip portions 210. The grip portions 210 may be positioned along a portion of a surface of the body 202, in particular where a user is expected to grip or rest the controller 200 during normal use. The grip portions 210 may be formed of a soft, comfortable substance such as a polymer foam. The grip portions 210 may also wrap around to a bottom surface of the game controller 200 so that the controller 200 may be place on various surfaces and furniture without scratching, chipping, sliding, or causing loud noises.

The game controller 200 may optionally include one or more secondary buttons 212. The secondary buttons 212 may perform any setup, maintenance, configuration, or control functions useful in game play. This may include, for example, starting a game, exiting a game, quitting a game, configuring a game, setting up a new game, entering a security code, entering a user's initials, logging into a network game system, initializing the game controller 200, managing a wireless connection to a computer or other device, and so forth. As depicted in FIG. 2, secondary buttons 212 may be positioned for convenient access by a user's index finger(s). However, it will be appreciated that other locations on the surface of the body 202 may similarly be employed, such as on a bottom surface where the secondary buttons 212 may be conveniently accessed by a user's ring fingers, or in the center of the top surface of the body 202. While two secondary buttons 212 are depicted, it will be appreciated that fewer or more secondary buttons 212 may be employed.

The game controller 200 may optionally include one or more supplemental user inputs and/or outputs 214. This may include any number of user input devices, such as a thumb pad, joystick, alphanumeric keypad, thumb ball, or any other device or devices useful for input of user data other than game play inputs. This may also include any number of output devices, such as a speaker, piezo-electric buzzer, a light, light emitting diodes, a liquid crystal display, a mechanical vibrator, or any other output device useful for providing status or control information to a user or enhancing game play. The supplemental inputs and/or outputs 214 may also, or instead, include electromechanical connectors such as USB ports, composite video connectors, audio connectors such as microphone or speaker I/O, Ethernet connectors, modular phone jacks, and the like.

FIG. 3 shows a functional block diagram of a game controller. The game controller 300, which may be the controller 200 described above with reference to FIG. 2, may include, for example, input/output 302, a memory 304, a processor 306, a communications interface 308, and a battery 310. In general these functional blocks may be of any conventional design, and cooperate to control operation of the game controller 300 and its participation in a game hosted by a game system such as that described above.

The input/output 302 may include, for example, device drivers to control operation of the primary buttons, secondary buttons, and/or supplemental input/outputs described above.

The memory 304 may be any volatile or nonvolatile memory. This may include, for example, memory such as read-only memory, programmable read-only memory, electronically erasable programmable read-only memory, random access memory, dynamic random access memory, double data rate random access memory, Rambus direct random access memory, flash memory, or any other volatile or non-volatile memory for storing program instructions (such as for the processor 306 described below), program data, game status, and program output or other intermediate or final results. The memory 304 may also include removable media such as a Flash Card, Memory Stick, or other similar hardware. In one embodiment, user identification information and other data, such as gaming history, may be stored on removable media so that a user may conveniently transport gaming data without a need for the entire controller 300.

The controller 300 may include a processor 306, such as a microprocessor, microcontroller, or other programmable device or devices, and may employ an operating system such as Windows CE, Windows XP embedded, or Linux. Upon this platform, the controller 300 may be programmed using any programming language or environment suitable for the chosen operating system. The controller 300 may also, or instead, employ application specific integrated circuits, programmable logic devices, or any other integrated circuits or other technology or combination of technologies suitable for controlling operation of the controller 300 in a game system such as the game system described above. More generally the processor 306 may include one or more microprocessors, microcontrollers, embedded microcontrollers, programmable digital signal processors, application specific integrated circuits, programmable gate arrays, programmable logic devices, programmable array logic and/or other programmable devices, along with internal and/or external memory. It should also be appreciated that operation of a game controller 300 may more generally be realized as computer executable code created using a structured programming language such as C, an object oriented programming language such as C++, or any other high-level or low-level programming language (including database programming languages and technologies) that may be compiled or interpreted to run on one of the above devices, as well as heterogeneous combinations of processors, processor architectures, or combinations of different hardware and software.

Thus the depiction of a single processor 306 should be understood as an example only, and in no way limiting the possible arrangements of hardware and software that may be suitably employed with the controller 300 as described herein. In one embodiment, the processor 306 includes a WinBond W567B010 chip. Functions to be coordinated by the processor 306 may include, for example, receiving and interpreting user input from the primary buttons and secondary buttons (such as by ensuring that only one primary button input is received in a trivia game), controlling output to output devices during game play, controlling communications with the game system through the communications interface, controlling user authentication and game play such as starting and stopping games, and so forth, along with any other status and control functions that might be usefully included in a game controller.

The communications interface 308 may include any suitable components for a wired or wireless connection to the gaming system described above. While a connection to a computer is one form of connection, it should be appreciated that the game controller 300 may also, or instead, be configured for connection to a set-top box, router, modem, telephone, cellular phone, or other device capable of transceiving data with the gaming system. The communications interface 308 may, for example, be configured for a wired Ethernet connection (e.g., 10/100 Base-T), a wireless local area network connection such as 802.11a, 802.11b, or 802.11g, a wireless wide area connection such as 802.16, an AirPort connection, an infrared connection, a Universal Serial Bus (“USB”) connection, a serial connection, a Firewire connection, a Bluetooth connection, or any other connection. These and/or other systems may be used as the communications interface 308 to a gaming system as described herein. The communications interface 308 may provide for one-way communications, such as where signals from the game controller 300 are received and interpreted by a computer which manages participating in the gaming system. Or the communications interface 308 may provide for two-way communication, such as where data concerning game status is transmitted to the game controller 300. It will be appreciated that these examples of communication are not limiting, and that a variety of data may be usefully communicated between the controller 300 and a gaming system as generally described herein.

The controller 300 may include a battery 310, which may include one or more commercially available batteries including Lithium ion batteries, Nickel Cadmium batteries, Nickel metal Hydride batteries, alkaline batteries, lead acid batteries, or any other rechargeable or non-rechargeable batteries suitable for providing power to the processor 306, memory 304, input/output 302 (and devices attached thereto), and communications interface 308 as generally described herein. The controller 300 may optionally include a power subsystem 312 adapted for connecting to a 100 VAC power supply, a 12V power supply, or some other power supply, or to derive power from a USB or other connection, along with suitable circuitry for converting the power supply into an electrical signal for driving other components of the controller 300.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A controller comprising:
a body, the body having a perimeter, the perimeter having a generally rounded shape and the body shaped and sized for cradling in two hands of a user;
a communications interface for connecting in a communicating relationship with a game system; and
four primary buttons having substantially equal size and positioned substantially equidistant from the perimeter, each one of the primary buttons configured to provide an input to game play for a game hosted by the game system.

2. The controller of claim 1 further comprising one or more secondary buttons.

3. The controller of claim 2 wherein one of the one or more secondary buttons is positioned for activation by an index finger of the user when the controller is cradled in the hands of the user.

4. The controller of claim 2 wherein the one or more secondary buttons control one or more of a game setup, a game configuration, a game start, and a game quit.

5. The controller of claim 1 wherein each one of the primary buttons is positioned for activation by a thumb of the user when the controller is cradled in the hands of the user.

6. The controller of claim 1 wherein the game system includes a multiplayer game.

7. The controller of claim 1 wherein the game system includes a single player game.

8. the controller of claim 1 wherein the game system includes a game hosted over a network.

9. The controller of claim 1 wherein the game system includes a game locally hosted at a computer.

10. The controller of claim 1 wherein the generally rounded shape is selected from a group consisting of a toroid, a circle, and an ellipse, and a rounded rectangle, and a rounded trapezoid.

11. The controller of claim 1 wherein the generally rounded shape is an ellipse having a major axis of between about four inches and about eight inches and a minor axis of between about three inches and about six inches.

12. The controller of claim 1 wherein each one of the four primary buttons has a different color.

13. The controller of claim 1 wherein the communications interface includes a wireless interface.

14. The controller of claim 13 wherein the wireless interface connects the controller to one or more of a set top box, a wireless router, a personal computer, a laptop, and a cellular phone.

15. The controller of claim 1 wherein the communications interface includes a bi-directional communications interface for transmission of data to and from the controller.

16. The controller of claim 1 wherein the game system includes a computer connected in a communicating relationship with the controller, the computer adapted to configure the controller for use in the game system.

17. The controller of claim 1 wherein the game system includes a computer connected in a communicating relationship with the controller, the computer adapted to set up a user for participation in the game system.

18. The controller of claim 1 wherein the game system includes a computer connected in a communicating relationship with the controller, the computer adapted to log a user into the game system and connect the controller to the game system through the computer for game play.

19. A controller comprising:
a body, the body having a perimeter, the body being generally rounded and shaped and sized for cradling in two hands of a user;
a communications interface for connecting in a communicating relationship with a game system; and
four forward buttons, each one of the forward buttons configured to select a forward action in a game hosted by the game system, and each one of the primary buttons positioned substantially equidistant from the perimeter of the body.

20. A controller comprising:
a body, the body having a perimeter, the body being generally rounded and shaped and sized for cradling in two hands of a user;
a communication means for connecting in a communicating relationship with a game system; and
four thumb button means for providing user inputs to game play with the user's thumbs.
